(19) United States
(12) Patent Application Publication
(10) Pub. No.: US 2011/0043842 A1
(43) Pub. Date: Feb. 24, 2011

(54) Information processing apparatus

(75) Inventors: Shingo Hitose, Saitama (JP); Noboru Koyama, Tokyo (JP); Tetsuya Hoshino, Tokyo (JP); Yuma Kokuzawa, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/806,083

(22) Filed: Aug. 5, 2010

(30) Foreign Application Priority Data
Aug. 21, 2009 (JP) P2009-192090

(51) Int. Cl. G06F 3/12

(52) U.S. Cl. 358/1.13

(57) ABSTRACT

Provided is an information processing apparatus including a printer portion performing a printing process. The printer portion has a sheet-discharge outlet for discharging a sheet, an opening-closing door for opening and closing the sheet- discharge outlet, the door performing an opening/closing operation for the sheet-discharge outlet through rotation of a rotation shaft disposed to an end portion of the door, and an opening-closing door lock mechanism that maintains the sheet-discharge outlet in a closed state by a weight of the door in the case where the information processing apparatus is set to a second position different from a first position that is a printing position of the apparatus where printing is performed by the printer portion, the second position being a position where the weight of the door is applied toward the end portion of the rotation shaft.

### BACKGROUND OF THE INVENTION

1. Field of the Invention

The present invention relates to an information processing apparatus, and more particularly, to an information processing apparatus having a. photo frame function and a printer function, where an opening-closing door is disposed to a sheet discharge outlet for discharging a print sheet.

2. Description of the Related Art

Recently, digital photo frames have been widely used as an apparatus for displaying the type of a photographing-apparatus, which displays photographs taken by, for example, digital cameras. The digital photo frame has a function of allowing a recording medium such as a flash memory, in which images taken by the digital camera are recorded, to be mounted and displaying the images recorded in the medium on a display portion such as a liquid crystal display (LCD). A user may use the photo frame by selecting referential photographs from a plurality of image data recorded in the medium and displaying the photographs on the display portion. An example of the photo frame is disclosed in Japanese Unexamined Patent Application Publication No. 2009-45139.

In addition, there is an example having a configuration where a USB port of a photo frame is connected through a USB cable to a printer, and an image displayed on a display portion is output to the printer.

In addition, there is an apparatus where a digital photo frame and a printer are integrated. In the integrated apparatus, in the case where a printing process is performed, a sheet tray is mounted on the printer portion so as to perform the printing process.

In many cases, the apparatus where the digital photo frame and the printer are integrated is a small-sized apparatus. Therefore, only at the time of printing, the print sheet tray is mounted so as to perform the printing. In addition, a sheet discharge outlet for discharging the print sheets is provided to the apparatus, so that the printed sheets are discharged from the sheet discharge outlet.

In addition, for example, in the case of an apparatus for performing a color printing process using an ink ribbon mounted in an inner portion of a printer, printing for individual YMC colors are sequentially performed on the print sheet. In the printing process, first, one print sheet is taken from the sheet tray into the printer, and the printing for the “Y” color among the YMC colors is performed. When the printing for the “Y” color is finished, the sheet is discharged from the sheet discharge outlet to an external portion of the printer. Next, the discharged sheet is again taken into the printer, and the printing for the “M” color is performed. Next, when the printing for the “C” color is finished, the sheet is discharged from the sheet discharge outlet. The printing process is performed in the aforementioned order.

In this manner, in the case of performing the printing process, the small-sized printer apparatus performs a sheet discharging process and a sheet in-taking process by using the sheet discharge outlet. For example, in the apparatus where the printer and the photo frame are integrated, at the time of performing the printing process, the sheet discharge outlet is necessarily in the open state. However, in the case where the apparatus is used as the photo frame, if the sheet discharge outlet is in the open state, dust may easily enter into the inner portion of the apparatus, which causes malfunction of the apparatus. Therefore, in the case where the apparatus is used as the photo frame, it is preferable that the sheet discharge outlet is in the closed state.

As a configuration for solving the above problem, an opening-closing door is contrived to be provided to the sheet discharge outlet. However, although the opening-closing door is provided, after the using of the printer, when the apparatus is changed over to the using of the photo frame, a user may forget to close the door. The user forgets to close the door, and thus the photo frame may be used for a long time in the state where the sheet discharge outlet is open. In this case, dust enters into the inner portion of the apparatus, so that the probability of an occurrence of a malfunction may be increased.

### SUMMARY OF THE INVENTION

It is desirable to provide an information processing apparatus having an image displaying function such as a photo frame and a printer function, where an opening-closing door is disposed to a sheet discharge outlet, wherein the opening-closing door is set to an open state at the time of using the printer and set to a closed state at the time of not using the printer, so that it is possible to prevent dust or the like from entering.

According to an embodiment of the present invention, there is provided an information processing apparatus having a printer portion which performs a printing process. The printer portion includes a sheet discharge outlet for discharging a print sheet, an opening-closing door for opening and closing the sheet discharge outlet, the opening-closing door being configured to perform an opening/closing operation for the sheet discharge outlet through rotation of a rotation shaft disposed to an end portion of the opening-closing door, and an opening-closing door lock mechanism which maintains the sheet discharge outlet in a closed state by a weight of the opening-closing door in the case where the information processing apparatus is set to a second position different from a first position that is a printing position of the information processing apparatus where printing is performed by the printer portion, the second position being a position where the weight of the opening-closing door is applied in the direction toward the end portion of the rotation shaft.

In addition, in the above embodiment of the information processing apparatus according to the invention, the information processing apparatus has a display portion which displays an image, wherein the second position is an image display position for displaying the image on the display portion, and wherein the opening-closing door lock mechanism maintains the sheet discharge outlet in the closed state by the weight of the opening-closing door in the case where the image display position is a position where the weight of the opening-closing door is applied in the direction toward the end portion of the rotation shaft.

In addition, in the above embodiment of the information processing apparatus according to the invention, the information processing apparatus further has an opening-closing door automatic rotation mechanism for allowing the opening-closing door to close the sheet discharge outlet by the weight of the opening-closing door in the case where the information processing apparatus is set to the second position where the weight of the opening-closing door is applied in the direction toward the end portion of the rotation shaft.

In addition, in the above embodiment of the information processing apparatus according to the invention, the rotation shaft has an eccentrically conical shape where a central axis is deviated, wherein a bearing into which the rotation shaft is inserted is configured to have a recessed portion which is engaged with the eccentrically conical shape at the position where the opening-closing door is closed, and wherein the opening-closing door automatic rotation mechanism is configured as a combination of the rotation shaft and the bearing.

In addition, in the above embodiment of the information processing apparatus according to the invention, the rotation shaft has a sloping rail at a partial area of the end surface of the rotation shaft so that a protrusion amount is gradually increased in a circumferential direction, wherein a bearing into which the rotation shaft is inserted is configured to have a sloping groove which is engaged with the sloping rail at the position where the opening-closing door is closed, and wherein the opening-closing door automatic rotation mechanism is configured as a combination of the rotation shaft and the bearing.

In addition, in the above embodiment of the information processing apparatus according to the invention, the rotation shaft has a protrusion portion at a partial area of the end surface of the rotation shaft, wherein a bearing into which the rotation shaft is inserted is configured to have a recessed portion which is engaged with the protrusion portion at the position where the opening-closing door is closed, and wherein the opening-closing door lock mechanism is configured as a combination of the protrusion portion of the rotation shaft and the recessed portion of the bearing.

In addition, in the above embodiment of the information processing apparatus according to the invention, a rotation-shaft-formation surface, where the rotation shaft is formed, has a protrusion portion at a partial area of the rotation-shaft-formation surface of the rotation shaft, wherein a bearing-formation surface, where the bearing is formed, is configured to have a recessed portion which is engaged with the protrusion portion at the position where the opening-closing door is closed, and wherein the opening-closing door lock mechanism is configured as a combination of the protrusion portion of the rotation-shaft-formation surface and the recessed portion of the bearing-formation surface.

Other features and advantages of the invention will be clarified by the description based on the later-described embodiments of the invention and accompanying drawings.

According to the configuration of one embodiment of the invention, in the information processing apparatus such as a digital photo frame having a printer portion and a display portion, in the case where the apparatus is changed over from the position of using the printer to the position of displaying an image, the opening-closing door is allowed to operate so that the sheet discharge output is in the closed state by the weight of the opening-closing door and the state is maintained. For example, the rotation shaft of the opening-closing door is formed in an eccentrically conical shape, and the recessed portion of the bearing is formed as a shape that is engaged with the eccentrically conical shape of the rotation shaft in the state where the door is closed. Alternatively, a rail having a slope is formed on the end surface of the rotation shaft of the opening-closing door, and a groove provided to the recessed portion of the bearing is configured to be engaged with the sloping rail in the state where the door is closed. Alternatively, the rotation shaft and the bearing may be provided with a protrusion portion and a recessed portion which are engaged with each other in the state where the door is closed. According to the configuration, in the case where the apparatus is changed over from the position of using the printer to the position of displaying an image, the sheet discharge outlet of the printer portion is closed by the weight of the opening-closing door, so that it is possible to maintain the closed state. Accordingly, for example, at the time of using as the photo frame, it is possible to prevent dust or like from entering through the sheet discharge outlet.

### BRIEF DESCRIPTION OF THE DRAWINGS

FIGS. 1A to 1C are diagrams illustrating examples of states of use of an information processing apparatus according to an embodiment of the invention.

FIGS. 2A and 2B are diagrams illustrating an example of a process of using an information processing apparatus according to an embodiment of the invention as a printer.

FIGS. 3A to 3C are diagrams illustrating ideal setting of an opening-closing door in each state of use of an information processing apparatus according to an embodiment of the invention.

FIG. 4 is a diagram illustrating movements of an opening-closing door at a printing position and a horizontal image display position.

FIGS. 5A and 5B are diagrams illustrating movements of an opening-closing door at a printing position and a vertical image display position.

FIG. 6 is a diagram illustrating configurations of a rotation shaft and a bearing of an opening-closing door according to a first embodiment of the invention.

FIGS. 7A to 7C are diagrams illustrating configurations of the rotation shaft and the bearing of the opening-closing door according to the first embodiment of the invention.

FIGS. 8A and 8B are diagrams illustrating configurations of the rotation shaft and the bearing of the opening-closing door according to the first embodiment of the invention.

FIG. 9 is a diagram illustrating configurations of a rotation shaft and a bearing of an opening-closing door according to a second embodiment of the invention.

FIGS. 10A and 10B are diagrams illustrating configurations of the rotation shaft and the bearing of the opening-closing door according to the second embodiment of the invention.

FIGS. 11A and 11B are diagrams illustrating configurations of the rotation shaft and the bearing of the opening-closing door according to the second embodiment of the invention.

FIGS. 12A and 12B are diagrams illustrating configurations of the rotation shaft and the bearing of the opening-closing door according to the second embodiment of the invention.

FIG. 13 is a diagram illustrating configurations of a rotation shaft and a bearing of an opening-closing door according to a third embodiment of the invention.

FIGS. 14A to 14C are diagrams illustrating configurations of the rotation shaft and the bearing of the opening-closing door according to the third embodiment of the invention.

FIG. 15 is a diagram illustrating configurations of a rotation shaft and a bearing of an opening-closing door according to a fourth embodiment of the invention.

FIGS. 16A to 16C are diagrams illustrating configurations of the rotation shaft and the bearing of the opening-closing door according to the fourth embodiment of the invention.

### DESCRIPTION OF THE PREFERRED EMBODIMENTS

Hereinafter, an information processing apparatus according to embodiments of the invention will be described with reference to the drawings. The description is made in the following order.

1. Overview of Information Processing Apparatus According to an Embodiment of the Invention

2. Basic Operations of Opening-closing Door

3. First Embodiment of the Invention

4. Second Embodiment of the Invention

5. Third Embodiment of the Invention

6. Fourth Embodiment of the Invention

7. Other Embodiments of the Invention

### [1. Overview of Information Processing Apparatus According to an Embodiment of the Invention]

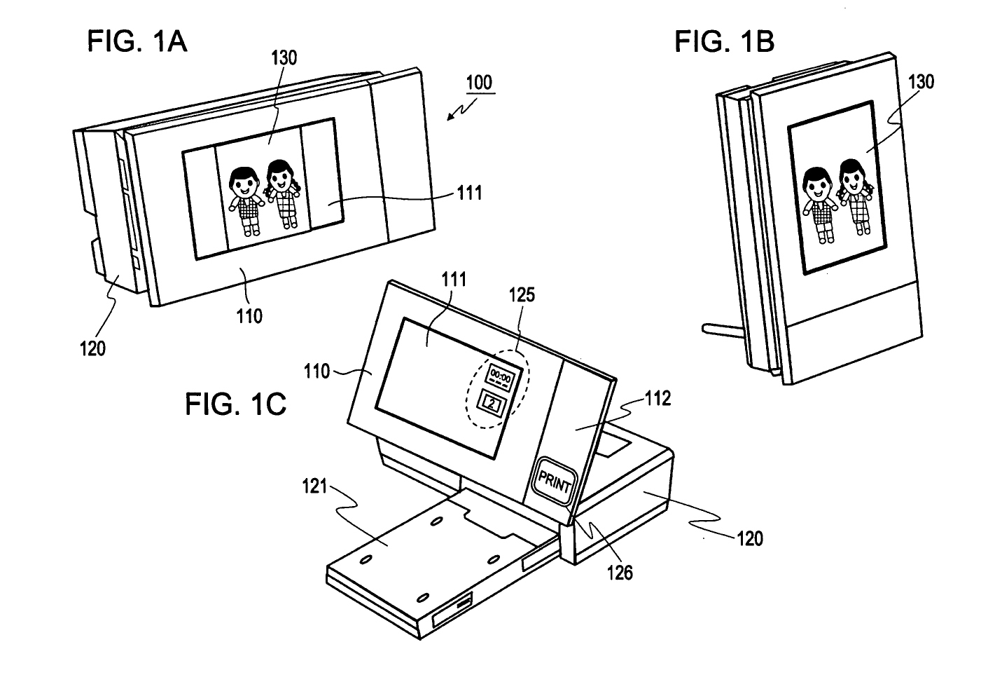

First, the overview of the information processing apparatus according to an embodiment of the invention is described with reference to FIGS. 1A to 1C. The information processing apparatus according to the embodiment of the invention is an apparatus having an image displaying function and a printer function. The information processing apparatus has a so-called digital photo frame function and a printer function. FIGS. 1A to 1C illustrate states of use of the information processing apparatus 100 according to the embodiment of the invention.

FIGS. 1A to 1C individually illustrate three states of use of the information processing apparatus 100 according to an embodiment of the invention. FIGS. 1A and 1B illustrate the states of use as a digital photo frame, and FIG. 1C illustrates the state of use as a printer.

Respective positions set in the states of use illustrated in FIGS. 1A to 1C are defined as below: a horizontal image display position (see FIG. 1A), a vertical image display position (see FIG. 1B), and a printing position (see FIG. 1C).

The horizontal image display position illustrated in FIG. 1A is suitable to display a horizontally oriented displayed image on a display portion 111.

The vertical image display position illustrated in FIG. 1B is suitable to display a vertically oriented displayed image on the display portion 111.

The printing position illustrated in FIG. 1C is suitable to perform a printing process using a printer portion 120.

As illustrated in FIGS. 1A to 1C, the information processing apparatus 100 includes a photo frame portion 110 having the display portion 111 constructed with a liquid crystal display portion (LCD) or the like and the printer portion 120. The photo frame portion 110 and the printer portion 120 are connected to each other through a rotation shaft which is disposed in the vicinity of a lower end portion in FIG. 1A so as to be allowed to rotate. By the rotation, the printing position is set up as illustrated in FIG. 1C.

The image display positions illustrated in FIGS. 1A and 1B are a closed state where the photo frame portion 110 is closely in contact with the printer portion 120. The image display positions illustrated in FIGS. 1A and 1B are merely different from each other in terms of horizontal and vertical arrangements. The printing position illustrated in FIG. 1C is an open state where the photo frame portion 110 is rotated so as to be separated from the printer portion 120.

The information processing apparatus 100 includes a positioning sensor for determining which state it is in among the states of three positions of the horizontal image display position, the vertical image display position, and the printing position. For example, a three-dimensional sensor is provided in an inner portion of the information processing apparatus 100.

Based on detection information of the sensor, in each of the horizontal image display position and the vertical image display position, the displayed image 130 may be appropriately displayed in terms of the up-and-down direction. In the case where the information processing apparatus 100 is determined to be at the printing position, as illustrated in FIG. 1C, printing-associated information 125 including control information or setup information of the printer portion 120 is displayed on the display portion 111.

In addition, at the printing position and in the case where the sheet tray 121 or the like is completely mounted and the printing startable state is determined to be set up, a printer icon 126 such as a printer operating switch is displayed on an operation panel 112 which is disposed in the right end portion of the photo frame portion 110.

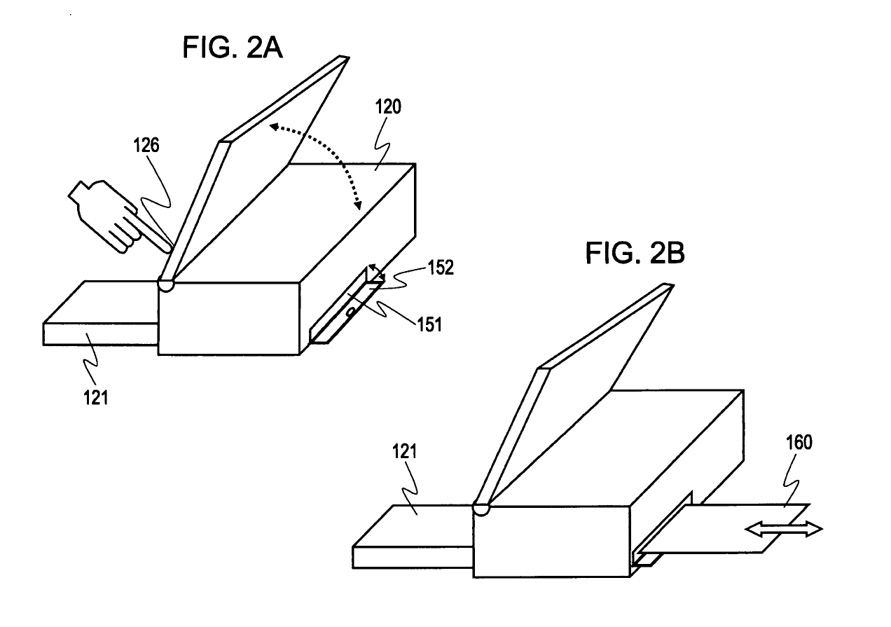

In the case where the information processing apparatus 100 according to the embodiment of the invention is used as a printer, the information processing apparatus 100 is set to the printing position illustrated in FIG. 1C, and the sheet tray 121 is mounted. The procedure of performing the printing process is described with reference to FIGS. 2A and 2B.

When the information processing apparatus 100 is used as a printer, the information processing apparatus 100 is set to the printing position illustrated in FIG. 1C, and the sheet tray 121 is mounted as illustrated in FIG. 2A. Next, when a user touches or pushes the printer icon 126 having a character line “PRINT” illustrated in FIG. 1C, the printing starts. Alternatively, when the user operates a printing starting switch disposed on an auxiliary remote controller, the printing starts. Since the surface of the printer icon 126 illustrated in FIG. 1C is configured as a touch sensor, a user's finger contact is detected. The detection information is input to a controller in the information processing apparatus 100, and the operation of the printer portion 120 starts under the control of the controller. In addition, a validation process of the touch sensor is also performed in synchronization with a process of displaying the printer icon 126. Therefore, in the state where the information processing apparatus 100 is set to the horizontal image display position as illustrated in FIG. 1A or the vertical image display position as illustrated in FIG. 1B, if the user touches the position above the printer icon 126, the printer operation does not start.

In addition, a sheet discharge outlet 151, which is an outlet of discharging paper sheets, is disposed in the rear side of the printer portion 120 illustrated in FIG. 2A. An opening-closing door 152 is configured to be rotated to open when the information processing apparatus 100 is set to the printing position.

When the printing is performed, as illustrated in FIG. 2B, the print sheets 160 are repeatedly input and output through the sheet discharge outlet 151 in the rear side of the printer portion 120, so that the printing process is performed. For example, the printing process is performed for each color of the colors YMC. In the printing process for each color, the print sheet 160 is input to and output from the printer portion 120 through the sheet discharge outlet 151. When the printing processes for all the colors are finished, a color-printed print sheet 160 is discharged.

### [2. Basic Operations of Opening-closing Door]

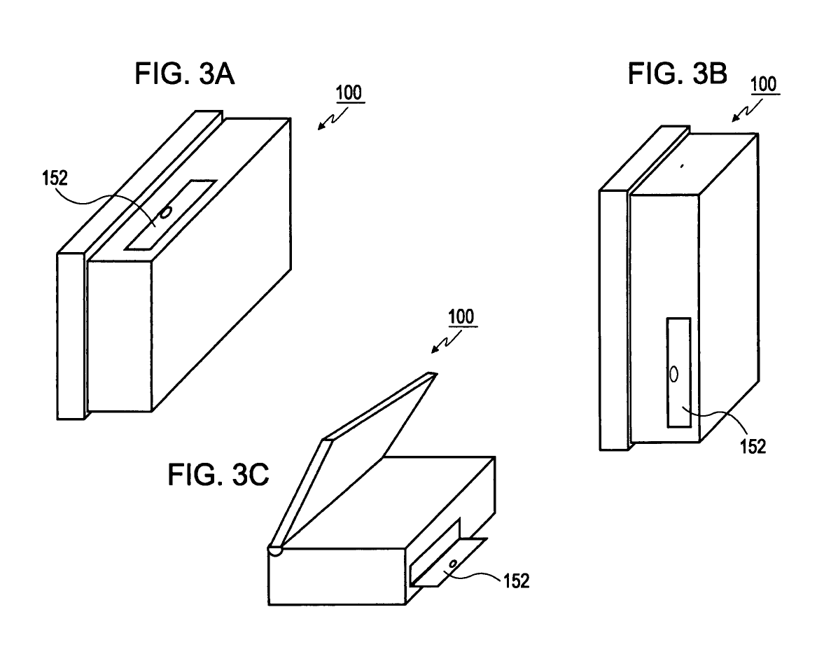

Next, a basic operation of the opening-closing door 152 of the sheet discharge outlet 151 is described. FIGS. 3A to 3C individually illustrate open and closed states of the opening-closing door 152 at the three positions described above with reference to FIGS. 1A to 1C. As described above with reference to FIGS. 1A to 1C, the information processing apparatus 100 may be used at the three positions of the horizontal image display position (see FIG. 1A), the vertical image display position (see FIG. 1B), and the printing position (see FIG. 1C).

As illustrated in FIG. 3C, at the printing position, the opening-closing door 152 is necessarily in the open state. On the other hand, when the information processing apparatus 100 is at the horizontal image display position or the vertical image display position, in order to prevent dust or the like from entering, the opening-closing door 152 is preferably in the closed state as shown in FIGS. 3A and 3B.

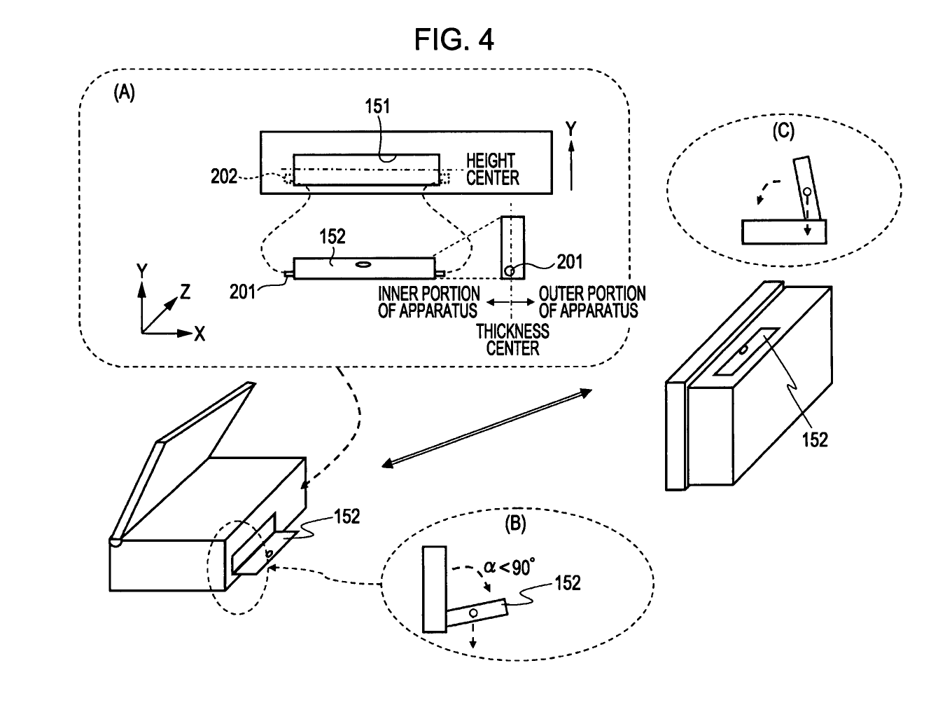

Mechanisms of the opening-closing door 152 and operations thereof at the time of changeover between the printing position and the horizontal image display position are described with reference to FIG. 4. As illustrated in a part (A), which is an exploded diagram, of FIG. 4, the opening-closing door 152 has rotation shafts 201 at the end portions thereof. The rotation shafts 201 are fitted to bearings 202 provided in the apparatus main body at the ends of the sheet discharge outlet 151. The rotation shafts 201 rotate in the bearings 202, so that the opening-closing door 152 opens and closes the sheet discharge outlet 151.

With regard to the changeover between the printing position and the horizontal image display position, by selecting the position of the rotation shaft 201 and the rotation angle α of the opening-closing door 152, the opening-closing door 152 may be allowed to automatically open and close by the weight of the opening-closing door 152.

The part (A) of FIG. 4 is the exploded diagram illustrating the arrangement at the printing position, and the X, Y, and Z directions correspond to a horizontal direction, a vertical direction, and a depth direction (inward direction of the apparatus), respectively. As illustrated in the part (A) of FIG. 4, the bearing 202 is disposed lower than the center (center in the height) of the sheet discharge outlet 151 in the vertical direction (Y direction) and the rotation shaft 201 is eccentrically disposed toward the inside of the apparatus from the center in the thickness direction of the opening-closing door 152. In addition, as illustrated in a part (B), which is an opening-closing diagram, of FIG. 4, the rotation angle α of the opening-closing door 152 is set to less than 90 degrees.

For example, according to the above set up, when the information processing apparatus 100 is set at the printing position, the opening-closing door 152 is in the open state due to its weight as illustrated in the part (B) of FIG. 4. When the information processing apparatus 100 is set at the horizontal image display position, the opening-closing door 152 is in the closed state as illustrated in a part (C) of FIG. 4.

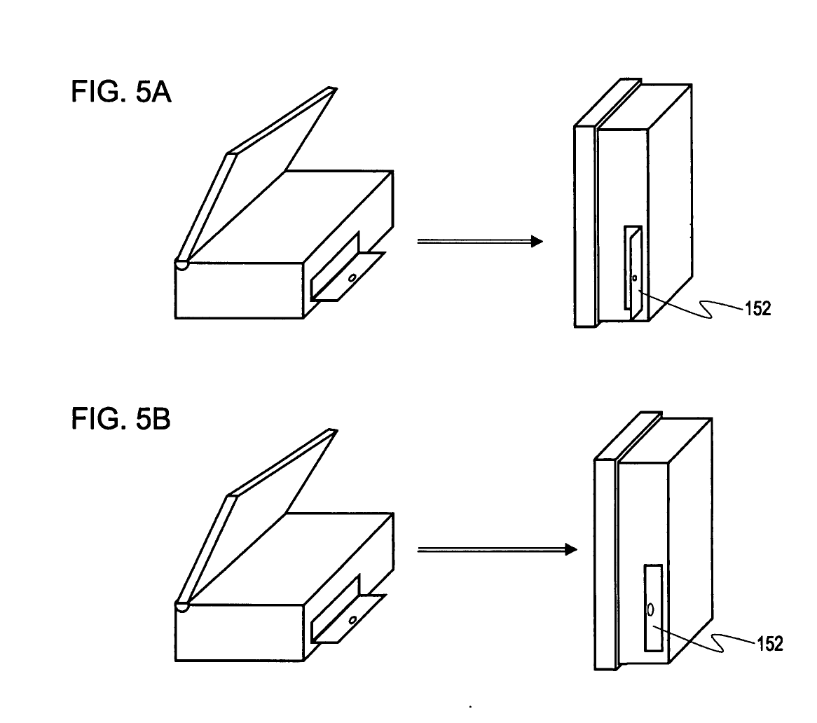

However, in the case where the information processing apparatus 100 is set at the vertical image display position as illustrated in FIG. 1B, the above arrangement of the rotation shaft 201 and the rotation angle does not contribute to the automatic opening and closing of the opening-closing door 152. In other words, as illustrated in FIG. 5A, for example, in the case where the information processing apparatus 100 is changed from the printing position illustrated in FIG. 1C to the vertical image display position illustrated in FIG. 1B, the opening-closing door 152 may remain in the open state.

Ideally, as illustrated in FIG. 5B, in the case where the information processing apparatus 100 is changed from the printing position to the vertical image display position, the opening-closing door 152 is preferably in the closed state. According to an embodiment of the invention, the opening-closing door 152 as illustrated in FIG. 5B may be implemented.

### [3. First Embodiment of the Invention]

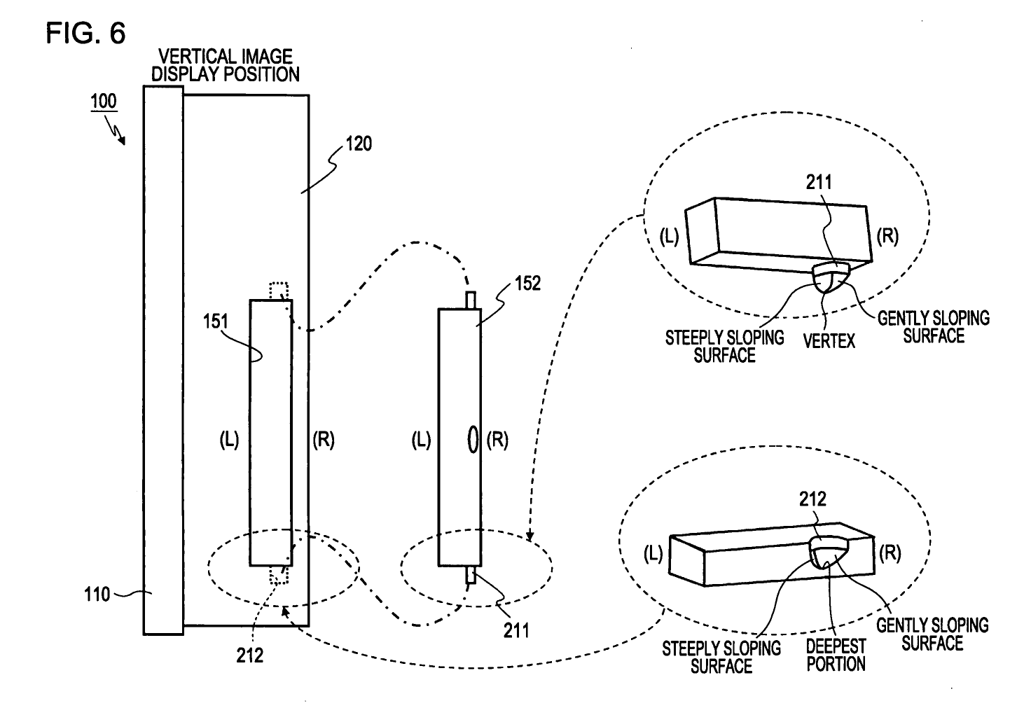

A first embodiment of the invention is described with reference to FIGS. 6 to 8B. FIG. 6 is a diagram illustrating structures of the rotation shaft of the opening-closing door and the bearing of the sheet discharge outlet according to the first embodiment of the invention. FIG. 6 illustrates in the left part thereof an information processing apparatus 100 set to the vertical image display position. The photo frame portion 110 is illustrated at the left side (L), and the printer portion 120 is illustrated at the right side (R). The opening-closing door 152 is illustrated as detached from the sheet discharge outlet 151 of the printer portion 120.

In addition, unlike the information processing apparatus 100 at the vertical image display position which is slightly sloped as illustrated in FIG. 1B, FIG. 6 illustrates the information processing apparatus 100 at the vertical image display position which is vertically erected in an approximately rectangular shape. In the first embodiment, at the vertical image display position, a rotation shaft 211 at the lower side of the opening-closing door 152 and a bearing 212 at the lower side of the sheet discharge outlet 151 are modified. By using the configuration of the first embodiment, in the completely vertical setup like the information processing apparatus 100 illustrated in FIG. 6 as well as in the setup of the slightly sloped vertical image display position illustrated in FIG. 1B, the opening-closing door 152 is automatically closed.

In addition, the rotation shaft and the bearing at the upper sides (the upper side at the vertical image display position) of the opening-closing door 152 and the sheet discharge outlet 151 illustrated in FIG. 6 may be configured as a combination of a typical columnar rotation shaft and a typical cylindrical bearing.

Detailed configurations of the rotation shaft 211 at the lower side of the opening-closing door 152 and the bearing 212 at the lower side of the sheet discharge outlet 151 at the vertical image display position are described.

The rotation shaft 211 at the lower side of the opening-closing door 152 is enlarged and illustrated in the upper right part of FIG. 6.

The bearing 212 at the lower side of the sheet discharge outlet 151 is enlarged and illustrated in the lower right part of FIG. 6.

Symbols (L) and (R) in FIG. 6 are provided for clarifying the directions of the rotation shafts and the bearings. That is, (L) denotes the left side, and (R) denotes the right side. The left side and right side denoted by (L) and (R) in the upper and lower right parts correspond to the left side (L) and right side (R) illustrated with each of the information processing apparatus 100 and the opening-closing door 152. The direction of the rotation shaft 211 illustrated in the upper right part of FIG. 6 coincides with the direction of the bearing 212 illustrated in the lower right part of FIG. 6, and this state corresponds to the state where the sheet discharge outlet 151 is closed.

The rotation shaft 211 at the lower side of the opening-closing door 152 illustrated in the upper right part of FIG. 6 has a conical protrusion portion, which does not have a columnar shape and a left-right symmetry. The protrusion portion has an eccentric configuration, in which the vertex of the cone is not coincident with the center of the rotation shaft 211 but deviated from the center in one direction. The one surface of the eccentrically conical portion is formed as a steeply sloping surface, and the other surface is formed as a gently sloping surface. In the example illustrated in the figure, the L side is the steeply sloping surface, and the R side is the gently sloping surface.

The bearing 212 at the lower side of the sheet discharge outlet 151 illustrated in the lower right part of FIG. 6 includes a shape corresponding to the eccentrically conical shape illustrated in the upper right part of FIG. 6. In other words, the bearing 212 has a recess portion corresponding to the eccentrically conical shape. The bearing 212 has a shape so as to be engaged with the rotation shaft 211 when the opening-closing door 152 is in the state of closing the sheet discharge outlet 151. One surface of the recess portion is formed as a steeply sloping surface, and the other surface is formed as a gently sloping surface. In the example illustrated in the figure, the L side is the steeply sloping surface, and the R side is the gently sloping surface.

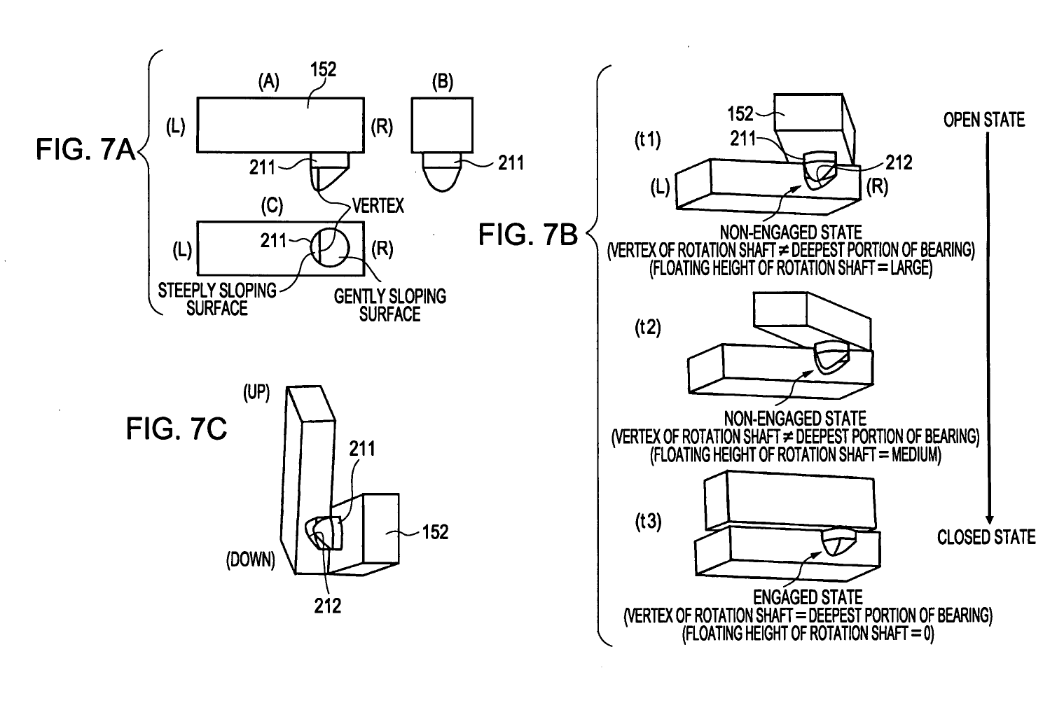

The detailed structures of the rotation shaft 211 and the bearing 212 according to the embodiment and the opening/closing operations of the opening-closing door 152 are described with reference to FIGS. 7A to 7C.

FIG. 7A includes a part (A), a part (B), and a part (C) that are a side view, a front view, and a bottom view of the rotation shaft 211, respectively. The side view of the rotation shaft 211 illustrated in the part (A) of FIG. 7A corresponds to a view as viewed in front of the vertical image display position of FIG. 6. The front view of the part (B) corresponds to a view as viewed from the (R) side of the vertical image display position of FIG. 6. The bottom view of the part (C) corresponds to a view as viewed from the bottom side of the vertical image display position of FIG. 6.

FIG. 7B illustrates the movements of the opening-closing door 152 as a time sequence in the case where the information processing apparatus 100 is changed over from the printing position to the vertical image display position. The figure illustrates movements when the opening-closing door 152 is gradually closed as a time sequence of (t1), (t2) and (t3) in the direction from up to down.

The time (t1) illustrates the state immediately after the information processing apparatus 100 that is previously set to the printing position is set to the vertical image display position. At this time, the opening-closing door 152 is in the open state. In addition, FIG. 7C illustrates the state of the time when the information processing apparatus 100 is set to the printing position. The (up) side and the (down) side at the printing position illustrated in FIG. 7C correspond to the L (left) side and the R (right) side at the time (t1) of FIG. 7B.

At the time (t1), the rotation shaft 211 of the opening-closing door 152 and the bearing 212 are not in the engaged state (closely contacted state). In other words, the vertex of the eccentrically conical rotation shaft 211 of the opening-closing door 152 is not coincident with the deepest portion of the bearing 212, but the vertex of the eccentrically conical rotation shaft 211 of the opening-closing door 152 is on the gently sloping surface of the bearing 212. In this state, the rotation shaft 211 of the opening-closing door 152 is slightly floated upward from the bearing 212.

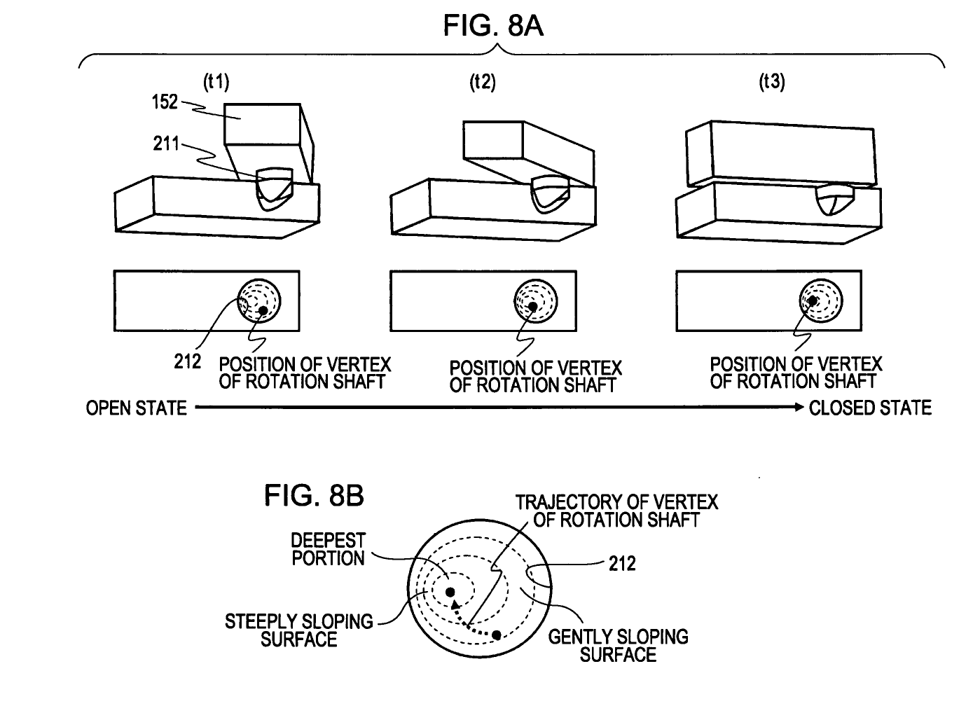

FIG. 8A illustrates the movement sequence of the vertex of the rotation shaft 211 on the bearing 212 as the same timing as the times (t1) to (t3) of FIG. 7B.

FIG. 8B illustrates the movement trajectory of the vertex of the rotation shaft 211 on the bearing 212 from the time (t1) to the time (t3).

At the time (t1) of FIG. 7B, the vertex of the eccentrically conical shape formed in the rotation shaft 211 of the opening-closing door 152 is to drop downward due to the weight of the opening-closing door 152. As a result, the vertex moves in the direction that the vertex slidingly drops along the gently sloping surface of the bearing 212. According to the movement, the rotation shaft 211 is allowed to rotate, so that the opening-closing door 152 rotates in the direction for closing the sheet discharge outlet 151.

The time (t2) of FIG. 7B corresponds to a view illustrating the transient step. At this time (t2), the rotation shaft 211 of the opening-closing door 152 and the bearing 212 are still not in the engaged state (closely contacted state). In other words, the vertex of the eccentrically conical rotation shaft 211 of the opening-closing door 152 has not coincided with the deepest portion of the bearing 212, but the vertex of the rotation shaft 211 of the opening-closing door 152 is on the gently sloping surface of the bearing 212.

As understood from FIGS. 8A and 8B, as time elapses from the time (t1) to the time (t2), the vertex of the rotation shaft 211 moves to the position that is slightly lowered along the gently sloping surface of the bearing 212.

As time elapses, the state illustrated by the time (t3) of FIG. 7B is obtained. At the time (t3), the rotation shaft 211 of the opening-closing door 152 and the bearing 212 are in the engaged state (closely contacted state). In other words, in this state, the vertex of the eccentrically conical rotation shaft 211 of the opening-closing door 152 coincides with the deepest portion of the bearing 212. In this state, the opening-closing door 152 completely closes the sheet discharge outlet 151.

As understood from FIGS. 8A and 8B, as time goes to the time (t3), the vertex of the rotation shaft 211 moves to the deepest portion of the bearing 212, so that the opening-closing door 152 is fixed at the position. In other words, the opening-closing door 152 is in a locked state, so that the opening-closing door 152 is fixed.

In this manner, in the first embodiment of the invention, the rotation shaft 211 of the opening-closing door 152 has the eccentrically conical portion, and the bearing 212 of the sheet discharge outlet 151 has the recessed portion which is engaged with the shape of the rotation shaft 211 in the state where the opening-closing door 152 is closed. According to the configuration, in the case where the information processing apparatus 100 is set to a position where the weight of the opening-closing door 152 is applied in the direction toward the end portion of the rotation shaft 211, for example, in the case where the information processing apparatus 100 is set to the vertical image display position, due to the weight of the opening-closing door 152, the opening-closing door 152 rotates to close the sheet discharge outlet 151, so that the opening-closing door 152 is in the fixed state (locked state) of closing the sheet discharge outlet 151. According to the configuration of the embodiment, in the case where a user changes the position of the information processing apparatus 100 from the printing position to the vertical image display position, if the user forgets to close the opening-closing door 152, since the opening-closing door 152 automatically rotates so as to close the sheet discharge outlet 151, it is possible to prevent dust or the like from entering.

### [4. Second Embodiment of the Invention]

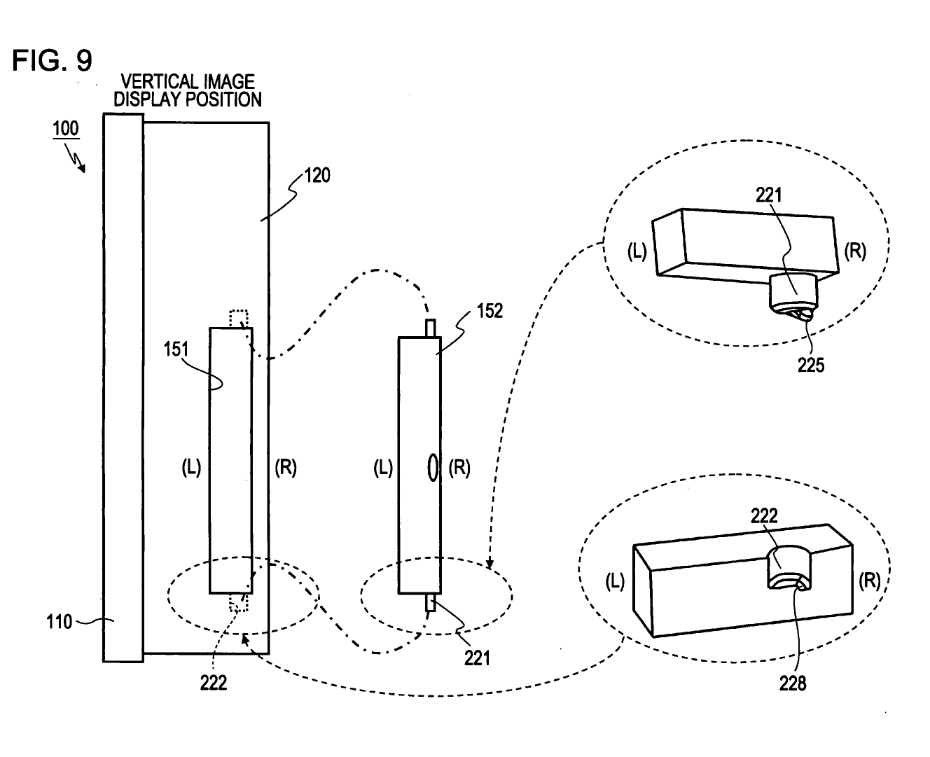

A second embodiment of the invention is described with reference to FIGS. 9 to 12B. FIG. 9 is a diagram illustrating structures of a rotation shaft of an opening-closing door and a bearing of a sheet discharge outlet of a printer portion according the second embodiment of the invention. FIG. 9 illustrates in the left part thereof an information processing apparatus 100 set to the vertical image display position. A photo frame portion 110 is illustrated at the left side (L), and a printer portion 120 is illustrated at the right side (R). An opening-closing door 152 is illustrated as detached from a sheet discharge outlet 151 of the printer portion 120. In addition, similarly to FIG. 6 referred to in the above first embodiment, the information processing apparatus 100 which is illustrated as the vertical image display position in FIG. 9 is illustrated as a configuration where the information processing apparatus 100 is vertically erected in an approximately rectangular shape.

Similarly to the first embodiment, in the second embodiment, at the vertical image display position, the rotation shaft 221 at the lower side of the opening-closing door 152 and the bearing 222 at the lower side of the sheet discharge outlet 151 are modified. By using the configuration of the second embodiment, in the completely vertical setup like the information processing apparatus 100 illustrated in FIG. 9 as well as in the setup of the slightly sloped vertical image display position illustrated in FIG. 1B, the opening-closing door 152 is configured to be automatically closed.

In addition, the rotation shaft and the bearing at the upper sides (the upper side at the vertical image display position) of the opening-closing door 152 and the sheet discharge outlet 151 illustrated in FIG. 9 may be configured as a combination of a typical columnar rotation shaft and a typical cylindrical bearing.

Detailed configurations of the rotation shaft 221 at the lower side of the opening-closing door 152 and the bearing 222 at the lower side of the sheet discharge outlet 151 at the vertical image display position are described.

The rotation shaft 221 at the lower side of the opening-closing door 152 is enlarged and illustrated in the upper right part of FIG. 9.

The bearing 222 at the lower side of the sheet discharge outlet 151 is enlarged and illustrated in the lower right part of FIG. 9.

Symbols (L) and (R) denote the left side and right side in FIG. 9. The left side and right side denoted by (L) and (R) in the upper right part and lower right part correspond to the left side (L) and right side (R) illustrated with each of the information processing apparatus 100 and the opening-closing door 152. The direction of the rotation shaft 221 illustrated in the upper right part of FIG. 9 coincides with the direction of the bearing 222 illustrated in the lower right part of FIG. 9, and this state corresponds to the state where the sheet discharge outlet 151 is closed.

The rotation shaft 221 at the lower side of the opening-closing door 152 illustrated in the upper right part of FIG. 9 has a sloping rail 225.

In addition, the bearing 222 at the lower side of the sheet discharge outlet 151 illustrated in the lower right part of FIG. 9 has a sloping groove 228 which is engaged with the sloping rail 225 of the rotation shaft 221 when the opening-closing door 152 is in the closed state.

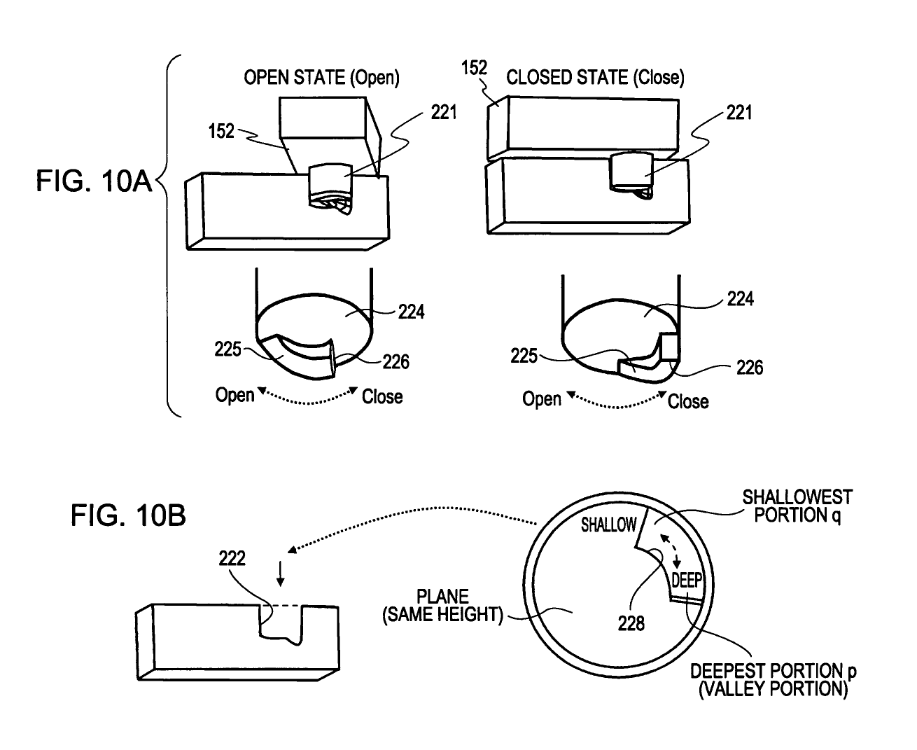

The detailed structures of the rotation shaft 221 and the bearing 222 and the opening/closing operations of the opening-closing door 152 according to the embodiment are described with reference to FIGS. 10A and 10B.

FIG. 10A illustrates the detailed structure of the rotation shaft, and FIG. 10B illustrates the detailed structure of the bearing.

FIG. 10A illustrates the detailed configuration of the rotation shaft 221 when the opening-closing door 152 is in the open state and the detailed configuration of the rotation shaft 221 when the opening-closing door 152 is in the closed state. As illustrated in FIG. 10A, the rotation shaft 221 has a cylindrical shape, and the sloping rail 225 is disposed on a bottom surface 224 of the rotation shaft 221.

The sloping rail 225 is configured as a sloping surface along the circumferential direction in a partial area of a circle constituting the bottom surface 224 of the rotation shaft 221. In the configuration of the sloping rail 225, the highest point protruding from the bottom surface 224 of the rotation shaft 221 is defined as a vertex 226, and at the end point of the sloping surface, which is sloped from the vertex 226 along the circumferential direction, its height becomes equal to the height of the bottom surface 224 of the rotation shaft 221. The formation area for the sloping rail 225 is defined as the area of which angle is slightly larger than the rotation angle (rotation angel from the open state to the closed state) of the rotation shaft 221. For example, if the rotation angle (rotation angel from the open state to the closed state) of the rotation shaft is 90 degrees, the sloping rail 225 is formed in the area of which angle is slightly larger than 90 degrees in the circumferential area of the bottom surface 224 of the rotation shaft 221 (total 360-degree area).

As illustrated in FIG. 10B, the bearing 222 has a configuration where the sloping groove 228 is formed on a conical bottom surface. The sloping groove 228 is configured so that the sloping rail 225 of the rotation shaft 221 is engaged (in closely contact) with the sloping groove 228 in the closed state. As illustrated in of FIG. 10B, the sloping groove 228 of the bearing 222 is configured to have the deepest portion p (valley portion) through the shallowest portion q.

In the closed state of the sloping rail 225 of the rotation shaft 221, a vertex 226 of the sloping rail 225 reaches the deepest portion p of the sloping groove 228 of the bearing 222. As the sloping rail 225 goes to the open state, the vertex 226 of the sloping rail 225 moves to the shallowest portion q from the deepest portion p of the sloping groove 228 of the bearing 222.

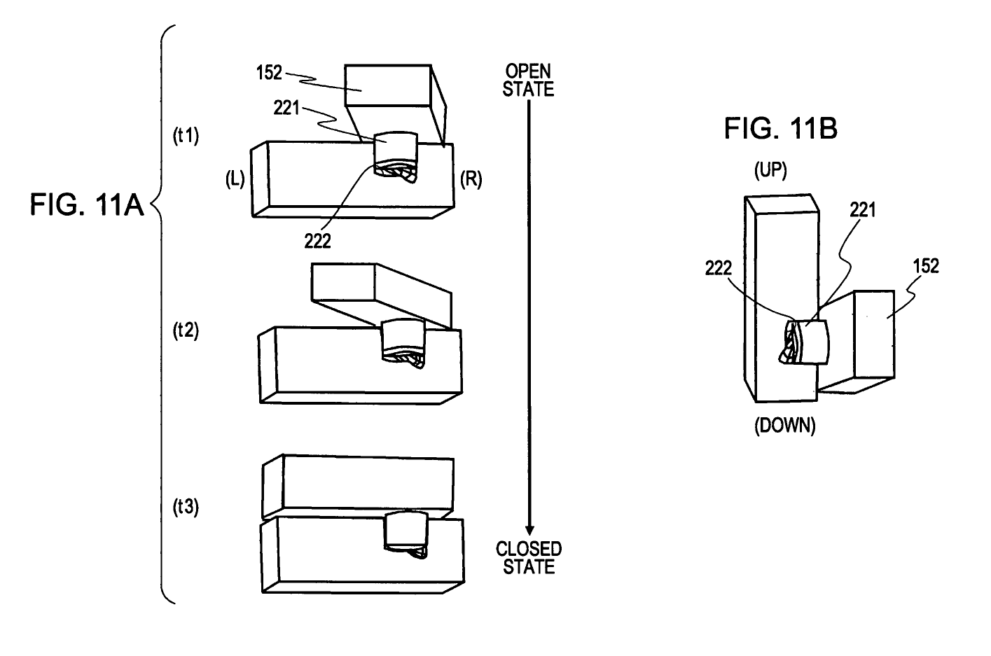

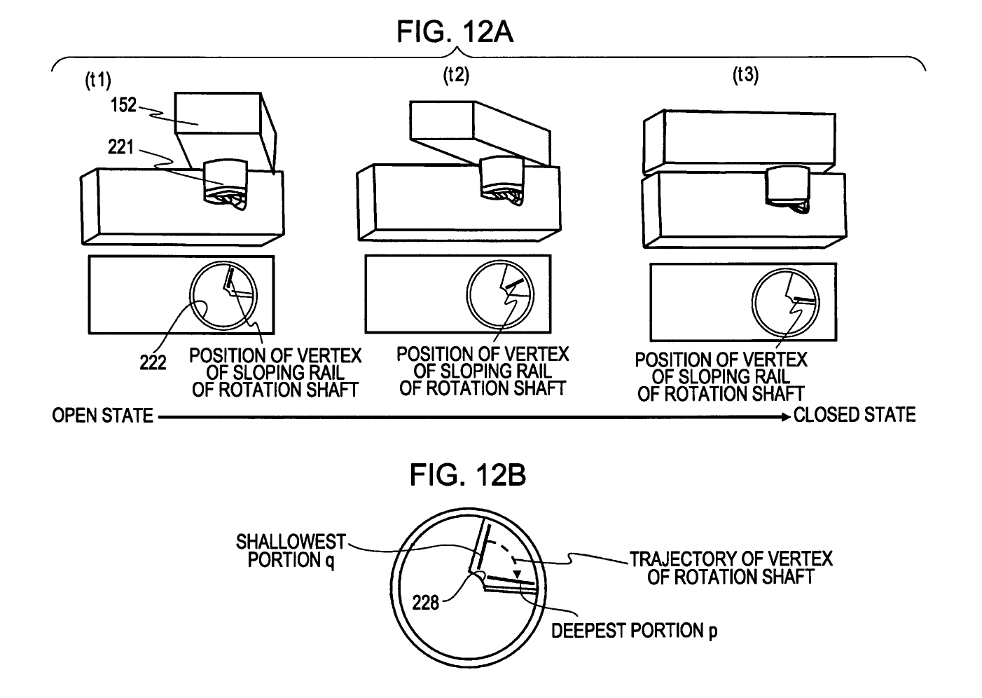

The opening/closing operations of the opening-closing door 152 through the rotation of the rotation shaft 221 in the bearing 222 according to the embodiment are described with reference to FIGS. 11A to 12B.

FIG. 11A illustrates the movements of the opening-closing door 152 as a time sequence in the case where the information processing apparatus 100 is changed over from the printing position to the vertical image display position. The figure illustrates movements when the opening-closing door 152 is gradually closed as a time sequence of (t1), (t2) and (t3) in the direction from up to down.

The time (t1) illustrates the state immediately after the information processing apparatus 100 that is previously set to the printing position is set to the vertical image display position. At this time, the opening-closing door 152 is in the open state. In addition, FIG. 11B illustrates the state of the time when the information processing apparatus 100 is set to the printing position. The (up) side and the (down) side at the printing position illustrated in FIG. 11B correspond to the L (left) side and the R (right) side at the time (t1) of FIG. 11A.

At the time (t1), the sloping rail 225 of the rotation shaft 221 of the opening-closing door 152 and the sloping groove 228 of the bearing 222 are not in the engaged state (closely contacted state).

In other words, the vertex 226 of the sloping rail 225 of the rotation shaft 221 of the opening-closing door 152 is not coincident with the deepest portion p of the sloping groove 228 of the bearing 222, but the vertex 226 of the sloping rail 225 of the rotation shaft 221 is in the vicinity of the shallowest portion q of the sloping surface of the bearing 222. In this state, the rotation shaft 221 of the opening-closing door 152 is slightly floated upward from the bearing 222.

FIG. 12A illustrates the movement sequence of the vertex 226 of the rotation shaft 221 on the bearing 222 as the same timing as the times (t1) to (t3) of FIG. 11A.

FIG. 12B illustrates the movement trajectory of the vertex 226 of the sloping rail 225 of the rotation shaft 221 from the time (t1) to the time (t3), that is, the movement trajectory in the sloping groove 228 in the bearing 222.

At the time (t1) of FIG. 11A, the vertex 226 of the sloping rail 225 formed in the rotation shaft 221 of the opening-closing door 152 is to drop downward due to the weight of the opening-closing door 152. As a result, the vertex 226 moves in the direction that the vertex 226 slidingly drops along the sloping groove 228 of the bearing 222. According to the movement, the rotation shaft 211 is allowed to rotate, so that the opening-closing door 152 rotates in the direction for closing the sheet discharge outlet 151.

The time (t2) of FIG. 11A corresponds to a view illustrating the transient step. At this time (t2), the vertex 226 of the sloping rail 225 of the rotation shaft 221 of the opening-closing door 152 and the deepest portion p of the sloping groove 228 of the bearing 222 are still not in the engaged state (closely contacted state). In other words, the vertex 226 of the sloping rail 225 of the rotation shaft 221 of the opening-closing door 152 has not coincided with the deepest portion p of the sloping groove 228 of the bearing 222, but the vertex 226 of the sloping rail 225 of the rotation shaft 221 is on the way of the sloping groove 228 of the bearing 222.

As understood from FIGS. 12A and 12B, as time elapses from the time (t1) to the time (t2), the vertex 226 of the sloping rail 225 of the rotation shaft 221 moves to the position that is slightly lowered along the sloping groove 228 of the bearing 222 (from a shallow position to a deep position).

As time elapses, the state illustrated by the time (t3) of FIG. 11A is obtained. At the time (t3), the sloping rail 225 of the rotation shaft 221 of the opening-closing door 152 and the sloping groove 228 of the bearing 222 are in the engaged state (closely contacted state). In other words, in this state, the vertex 226 of the sloping rail 225 of the opening-closing door 152 coincides with the deepest portion p of the sloping groove 228 of the bearing 222. In this state, the opening-closing door 152 completely closes the sheet discharge outlet 151.

As understood from FIGS. 12A and 12B, as time goes to the time (t3), the vertex 226 of the sloping rail 225 of the rotation shaft 221 moves to the deepest portion p of the sloping groove 228 of the bearing 222, so that the opening-closing door 152 is fixed at the position. In other words, the opening-closing door 152 is in a locked state, so that the opening-closing door 152 is fixed.

In this manner, in the second embodiment of the invention, the rotation shaft 221 of the opening-closing door 152 has the sloping rail 225 on the bottom surface 224 of the cylindrical shaft, and the bearing 222 of the sheet discharge outlet 151 has the sloping groove 228 which is engaged with the sloping rail 225 of the rotation shaft 221 in the state where the opening-closing door 152 is closed. According to the configuration, in the case where the information processing apparatus 100 is set to a position where the weight of the opening-closing door 152 is applied in the direction toward the end portion of the rotation shaft 221, more specifically, in the case where the information processing apparatus 100 is set to the vertical image display position, due to the weight of the opening-closing door 152, the opening-closing door 152 rotates to close the sheet discharge outlet 151, so that the opening-closing door 152 is in the fixed state (locked state) of closing the sheet discharge outlet 151. According to the configuration of the embodiment, in the case where a user changes the position of the information processing apparatus 100 from the printing position to the vertical image display position, if the user forgets to close the opening-closing door 152, since the opening-closing door 152 automatically rotates so as to close the sheet discharge outlet 151, it is possible to prevent dust or the like from entering.

### [5. Third Embodiment of the Invention]

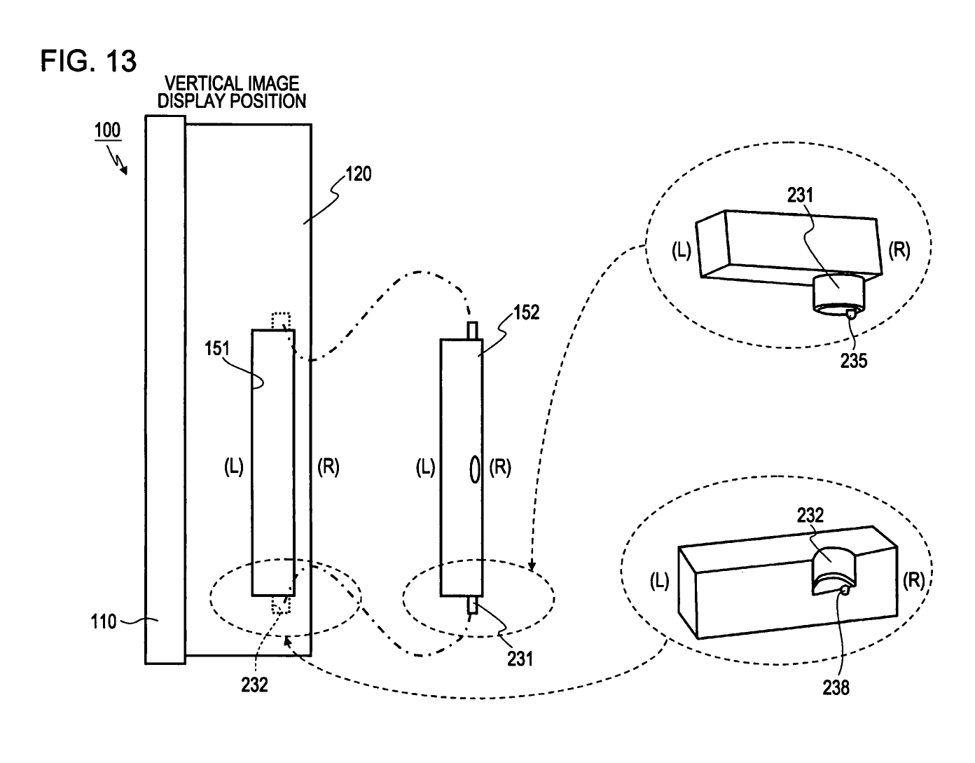

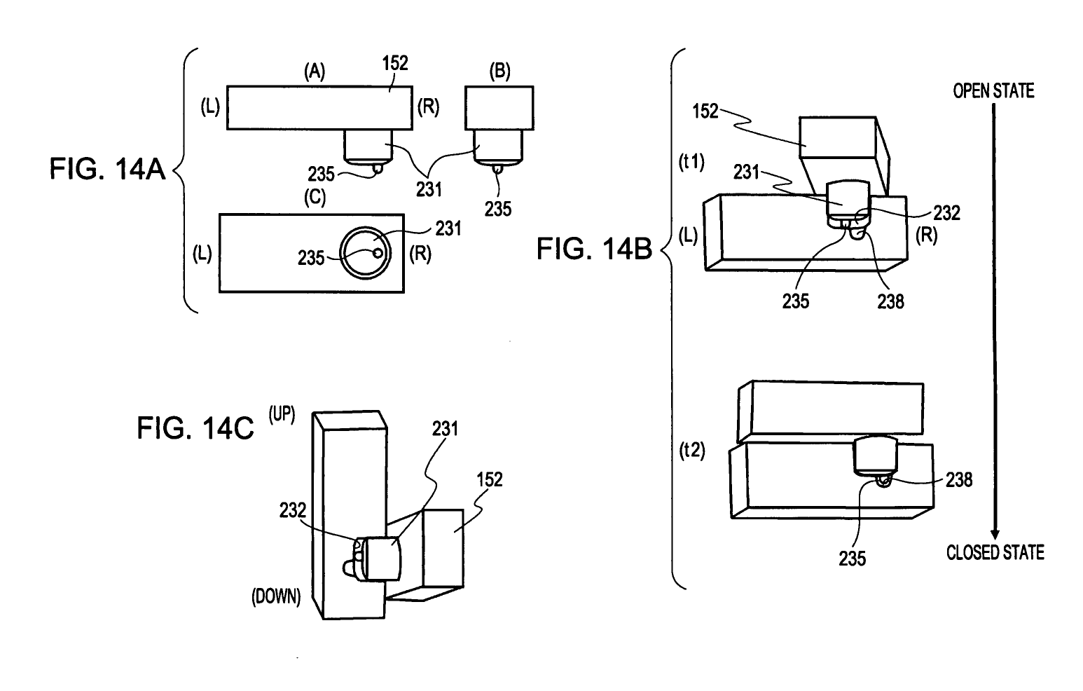

A third embodiment of the invention is described with reference to FIGS. 13 to 14C. FIG. 13 is a diagram illustrating structures of a rotation shaft of an opening-closing door and a bearing of a sheet discharge outlet of a printer portion according the third embodiment of the invention. FIG. 13 illustrates in the left part thereof an information processing apparatus 100 set to the vertical image display position. A photo frame portion 110 is illustrated at the left side (L), and a printer portion 120 is illustrated at the right side (R). An opening-closing door 152 is illustrated as detached from a sheet discharge outlet 151 of the printer portion 120. In addition, similarly to FIGS. 6 and 9 referred to in the above first and second embodiments, FIG. 13 illustrates the information processing apparatus 100 at the vertical image display position which is vertically erected in an approximately rectangular shape.

Similarly to the first and second embodiments, in the third embodiment, at the vertical image display position, the rotation shaft 231 at the lower side of the opening-closing door 152 and the bearing 232 at the lower side of the sheet discharge outlet 151 are modified. By using the configuration of the third embodiment, in the completely vertical setup like the information processing apparatus 100 illustrated in FIG. 13 as well as in the setup of the slightly sloped vertical image display position illustrated in FIG. 1B, it is possible to fix the opening-closing door 152 in the closed state. In other words, a lock mechanism is provided.

In addition, the rotation shaft and the bearing at the upper sides (the upper side at the vertical image display position) of the opening-closing door 152 and the sheet discharge outlet 151 illustrated in FIG. 13 may be configured as a combination of a typical columnar rotation shaft and a typical cylindrical bearing.

Detailed configurations of the rotation shaft 231 at the lower side of the opening-closing door 152 and the bearing 232 at the lower side of the sheet discharge outlet 151 at the vertical image display position are described.

The rotation shaft 231 at the lower side of the opening-closing door 152 is enlarged and illustrated in the upper right part of FIG. 13.

The bearing 232 at the lower side of the sheet discharge outlet 151 is enlarged and illustrated in the lower right part of FIG. 13.

Symbols (L) and (R) denote the left side and right side in FIG. 13. The left side and right side denoted by (L) and (R) in the upper right part and lower right part correspond to the left side (L) and right side (R) illustrated with each of the information processing apparatus 100 and the opening-closing door 152. The direction of the rotation shaft 231 illustrated in the upper right part of FIG. 13 coincides with the direction of the bearing 232 illustrated in the lower right part of FIG. 13, and this state corresponds to the state where the sheet discharge outlet 151 is closed.

The rotation shaft 231 at the lower side of the opening-closing door 152 illustrated in the upper right part of FIG. 13 has a protrusion portion 235 on the bottom surface of the rotation shaft 231.

In addition, the bearing 232 at the lower side of the sheet discharge outlet 151 illustrated in the lower right part of FIG. 13 has a recessed portion 238 which is engaged with the protrusion portion 235 of the rotation shaft 231 when the opening-closing door 152 is in the closed state.

The detailed structures of the rotation shaft 231 and the bearing 232 and the opening/closing operations of the opening-closing door 152 according to the embodiment are described with reference to FIGS. 14A to 14C.

FIG. 14A includes a part (A), a part (B), and a part (C) that are a side view, a front view, and a bottom view of the rotation shaft 231, respectively. The side view of the rotation shaft 231 illustrated in the part (A) of FIG. 14A corresponds to a view as viewed in front of the vertical image display position of FIG. 13. The front view of the part (B) corresponds to a view as viewed from the (R) side of the vertical image display position of FIG. 13. The bottom view of the part (C) corresponds to a view as viewed from the bottom side of the vertical image display position of FIG. 13.

FIG. 14B illustrates the movements of the opening-closing door 152 as a time sequence in the case where the information processing apparatus 100 is changed over from the printing position to the vertical image display position. The figure illustrates movements when the opening-closing door 152 is gradually closed as a time sequence of (t1) and (t2) in the direction from up to down.

The time (t1) illustrates the state immediately after the information processing apparatus 100 that is previously set to the printing position is set to the vertical image display position. At this time, the opening-closing door 152 is in the open state. In addition, FIG. 14C illustrates the state of the time when the information processing apparatus 100 is set to the printing position. The (up) side and the (down) side at the printing position illustrated in FIG. 14C correspond to the L (left) side and the R (right) side at the time (t1) of FIG. 14B.

At the time (t1), the protrusion portion 235 of the rotation shaft 231 of the opening-closing door 152 and the recessed portion 238 of the bearing 232 are not in the engaged state (closely contacted state).

In other words, the protrusion portion 235 of the rotation shaft 231 of the opening-closing door 152 is not coincident with the recessed portion 238 of the bearing 232, and the protrusion portion 235 of the rotation shaft 231 is on the plane, that is, the bottom surface of the bearing 232. In this state, the rotation shaft 231 of the opening-closing door 152 is slightly floated upward from the bearing 232.

By the user's operation of the opening-closing door 152, the state illustrated by the time (t2) of FIG. 14B is obtained. At the time (t2), the protrusion portion 235 of the rotation shaft 231 of the opening-closing door 152 and the recessed portion 238 of the bearing 232 are in the engaged state (closely contacted state). In other words, the protrusion portion 235 of the opening-closing door 152 coincides with the recessed portion 238 of the bearing 232. In this state, the opening-closing door 152 completely closes the sheet discharge outlet 151. The opening-closing door 152 is fixed at the position. In other words, the opening-closing door 152 is in a locked state, so that the opening-closing door 152 is fixed.

In this manner, in the third embodiment, the rotation shaft 231 of the opening-closing door 152 has the protrusion portion 235 on the bottom surface of the cylindrical shaft, and the bearing 232 of the sheet discharge outlet 151 has the recessed portion 238 which is engaged with the protrusion portion 235 of the rotation shaft 231 in the state where the opening-closing door 152 is closed. According to the configuration, in the case where the information processing apparatus 100 is set to a position where the weight of the opening-closing door 152 is applied in the direction toward the end portion of the rotation shaft 231, more specifically, in the case where the information processing apparatus 100 is set to the vertical image display position, due to the weight of the opening-closing door 152, the protrusion portion 235 provided to the rotation shaft 231 of the opening-closing door 152 is inserted into the recessed portion 238 provided to the bottom surface of the bearing 232 of the sheet discharge outlet 151, so that the opening-closing door 152 is in the fixed state (locked state) of closing the sheet discharge outlet 151. According to the configuration of the embodiment, in the case where a user changes the position of the information processing apparatus 100 from the printing position to the vertical image display position, if the user closes the opening-closing door 152, the opening-closing door 152 is prevented from opening, so that it is possible to prevent dust or the like from entering.

### [6. Fourth Embodiment of the Invention]

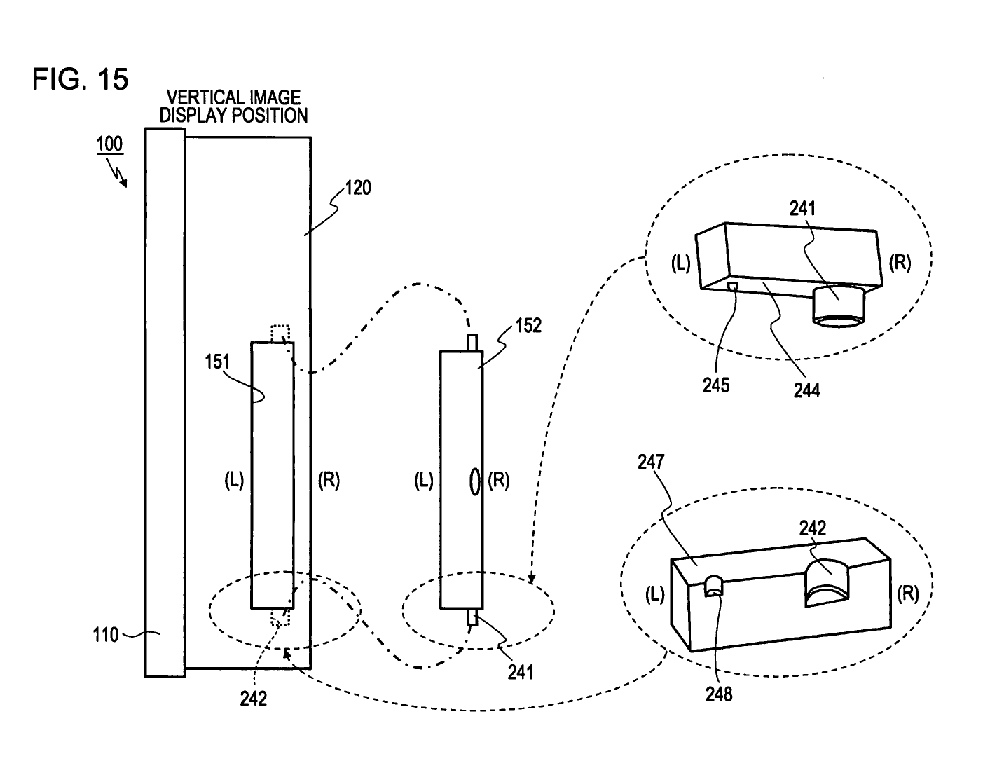

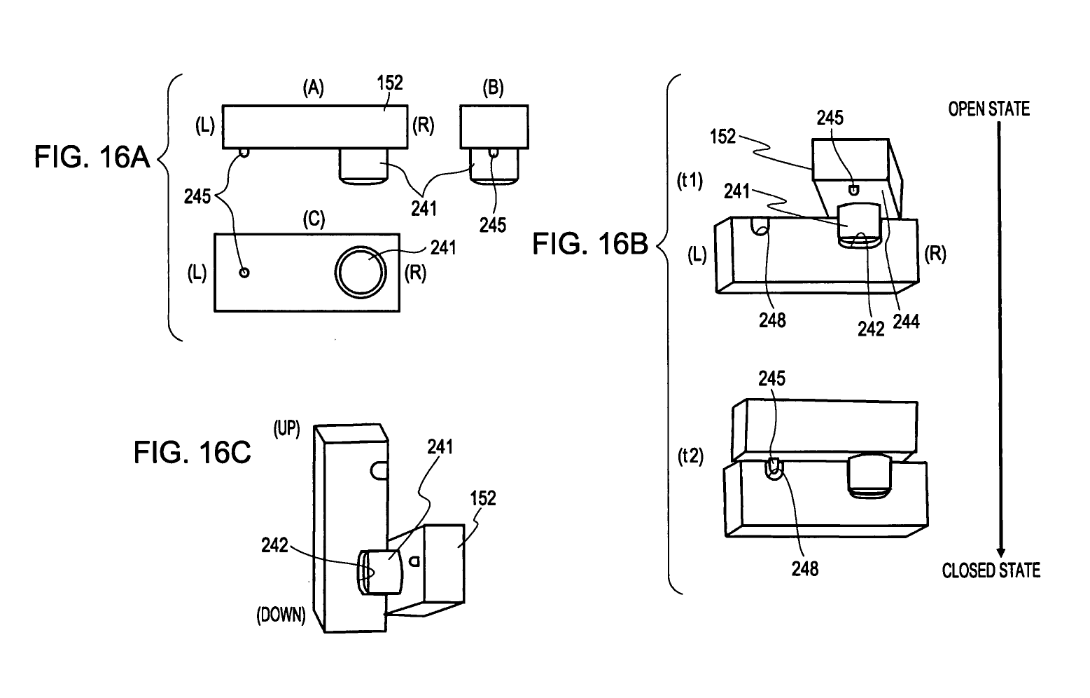

A fourth embodiment of the invention is described with reference to FIGS. 15 to 16C. FIG. 15 is a diagram illustrating structures of a rotation shaft of an opening-closing door and a bearing of a sheet discharge outlet of a printer portion according the fourth embodiment of the invention. FIG. 15 illustrates in the left part thereof an information processing apparatus 100 set to the vertical image display position. A photo frame portion 110 is illustrated at the left side (L), and a printer portion 120 is illustrated at the right side (R). An opening-closing door 152 is illustrated as detached from a sheet discharge outlet 151 of the printer portion 120. In addition, similarly to FIGS. 6, 9, and 13 referred to in the above first to third embodiments, FIG. 15 illustrates the information processing apparatus 100 at the vertical image display position which is vertically erected in an approximately rectangular shape.

In the fourth embodiment, at the vertical image display position, a rotation-shaft-formation surface 244 for the rotation shaft 241 at the lower side of the opening-closing door 152 and a bearing-formation surface 247 for the bearing 242 at the lower side of the sheet discharge outlet 151 are modified. By using the configuration of the fourth embodiment, in the completely vertical setup like the information processing apparatus 100 illustrated in FIG. 15 as well as in the setup of the slightly sloped vertical image display position illustrated in FIG. 1B, it is possible to fix the opening-closing door 152 in the closed state. In other words, a lock mechanism is provided.

In addition, the rotation shaft and the bearing at the upper sides (the upper side at the vertical image display position) of the opening-closing door 152 and the sheet discharge outlet 151 illustrated in FIG. 15 may be configured as a combination of a typical columnar rotation shaft and a typical cylindrical bearing.

Detailed configurations of the rotation-shaft-formation surface 244 for the rotation shaft 241 at the lower side of the opening-closing door 152 and the bearing-formation surface 247 for the bearing 242 at the lower side of the sheet discharge outlet 151 at the vertical image display position are described.

The rotation shaft 241 at the lower side of the opening-closing door 152 is enlarged and illustrated in the upper right part of FIG. 15.

The bearing 242 at the lower side of the sheet discharge outlet 151 is enlarged and illustrated in the lower right part of FIG. 15.

Symbols (L) and (R) denote the left side and right side in FIG. 15. The left side and right side denoted by (L) and (R) in the upper right part and lower right part correspond to the left side (L) and right side (R) illustrated with each of the information processing apparatus 100 and the opening-closing door 152. The direction of the rotation shaft 241 illustrated in the upper right part of FIG. 15 coincides with the direction of the bearing 242 illustrated in the lower right part of FIG. 15, and this state corresponds to the state where the sheet discharge outlet 151 is closed.

As illustrated in the upper right part of FIG. 15, the rotation shaft 241 at the lower side of the opening-closing door 152 is provided on the rotation-shaft-formation surface 244 on which a protrusion portion 245 is formed.

In addition, as illustrated in the lower right part of FIG. 15, the bearing-formation surface 247, at the lower side of the sheet discharge outlet 151, where the bearing 242 is formed, has a recessed portion 248 which is engaged with the protrusion portion 245 of the rotation-shaft-formation surface 244 of the opening-closing door 152 when the opening-closing door 152 is in the closed state.

The detailed structures of the embodiment and the opening/closing operations of the opening-closing door 152 are described with reference to FIGS. 16A to 16C.

FIG. 16A includes a part (A), a part (B), and a part (C) that are a side view, a front view, and a bottom view of a formation portion for the rotation shaft 241. The side view of the formation portion for the rotation shaft 241 illustrated in the part (A) of FIG. 16A corresponds to a view as viewed in front of the vertical image display position of FIG. 15. The front view of the part (B) corresponds to a view as viewed from the (R) side of the vertical image display position of FIG. 15. The bottom view of the part (C) corresponds to a view as viewed from the bottom side of the vertical image display position of FIG. 15.

FIG. 16B illustrates the movements of the opening-closing door 152 as a time sequence in the case where the information processing apparatus 100 is changed over from the printing position to the vertical image display position. The figure illustrates movements when the opening-closing door 152 is gradually closed as a time sequence of (t1) and (t2) in the direction from up to down.

The time (t1) illustrates the state immediately after the information processing apparatus 100 that is previously set to the printing position is set to the vertical image display position. At this time, the opening-closing door 152 is in the open state. In addition, FIG. 16C illustrates the state of the time when the information processing apparatus 100 is set to the printing position. The (up) side and the (down) side at the printing position illustrated in FIG. 16C correspond to the L (left) side and the R (right) side at the time (t1) of FIG. 16B.

At this time (t1), the protrusion portion 245 on the rotation-shaft-formation surface 244 for the rotation shaft 241 of the opening-closing door 152 and the recessed portion 248 in the bearing-formation surface 247 for the bearing 242 are not in the engaged state (closely contacted state).

In other words, the protrusion portion 245 on the rotation-shaft-formation surface 244 for the rotation shaft 241 of the opening-closing door 152 is not coincident with the recessed portion 248 in the bearing-formation surface 247, and the protrusion portion 245 on the rotation-shaft-formation surface 244 is on the plane, that is, on the bearing-formation surface 247. In this state, the rotation-shaft-formation surface 244 is slightly floated upward from the bearing-formation surface 247.

By the user's operation of the opening-closing door 152, the state illustrated by the time (t2) of FIG. 16B is obtained. At the time (t2), the protrusion portion 245 on the rotation-shaft-formation surface 244 for the rotation shaft 241 of the opening-closing door 152 and the recessed portion 248 in the bearing-formation surface 247 are in the engaged state (closely contacted state). In other words, the protrusion portion 245 on the rotation-shaft-formation surface 244 for rotation shaft 241 of the opening-closing door 152 coincides with the recessed portion 248 in the bearing-formation surface 247. In this state, the opening-closing door 152 completely closes the sheet discharge outlet 151. The opening-closing door 152 is fixed at the position. In other words, the opening-closing door 152 is in a locked state, so that the opening-closing door 152 is fixed.

In this manner, in the fourth embodiment, the opening-closing door 152 has the protrusion portion 245 on the rotation-shaft-formation surface 244, and the bearing-formation surface 247 for the bearing 242 of the sheet discharge outlet 151 has the recessed portion 248 which is engaged with the protrusion portion 245 in the state where the opening-closing door 152 is closed. According to the configuration, in the case where the information processing apparatus 100 is set to a position where the weight of the opening-closing door 152 is applied in the direction toward the end portion of the rotation shaft 241, more specifically, in the case where the information processing apparatus 100 is set to the vertical image display position, due to the weight of the opening-closing door 152, the protrusion portion 245 is inserted into the recessed portion 248 provided to the bearing-formation surface 247 for the bearing 242 of the sheet discharge outlet 151, so that the opening-closing door 152 is in the fixed state (locked state) of closing the sheet discharge outlet 151. According to the configuration of the embodiment, in the case where a user changes the position of the information processing apparatus 100 from the printing position to the vertical image display position, if the user closes the opening-closing door 152, the opening-closing door 152 is prevented from opening, so that it is possible to prevent dust or the like from entering.

### [7. Other Embodiments of the Invention]

Hereinbefore, the four embodiments, that is, the first to fourth embodiments have been described.

Among the above embodiment, in the first and second embodiments, the automatic opening-closing mechanism which automatically closes the opening-closing door at the vertical image display position and the lock mechanism which maintains the opening-closing door in the closed state at the vertical image display position are provided.

In the third and fourth embodiments, the lock mechanism which maintains the opening-closing door in the closed state is provided.

As well as the individual configurations of the above embodiments, combinations of the configurations may be implemented. Examples of the combined configurations may be as follows: a combination of the first embodiment and the third embodiment; a combination of the first embodiment and the fourth embodiment; a combination of the second embodiment and the third embodiment; and a combination of the second embodiment and the fourth embodiment.

Through the above combinations of the individual embodiments, the automatic opening-closing mechanism and the stabilized lock mechanism may be implemented.

Hereinbefore, the invention has been described with reference to particular embodiments. However, it should be noted that various changes and modifications may be made by those skilled in the art within the scope without departing from the spirit of the invention. In other words, since the invention is disclosed in an exemplary form, the invention should not be analyzed in a limited sense. The scope and spirit of the invention is defined by the appended claims.

The present application contains subject matter related to that disclosed in Japanese Priority Patent Application JP 2009-192090 filed in the Japan Patent Office on Aug. 21, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising a printer portion which performs a printing process,
the printer portion including
a sheet discharge outlet for discharging a print sheet,
an opening-closing door for opening and closing the sheet discharge outlet, the opening-closing door being configured to perform an opening/closing operation for the sheet discharge outlet through rotation of a rotation shaft disposed to an end portion of the opening-closing door, and
an opening-closing door lock mechanism that maintains the sheet discharge outlet in a closed state by a weight of the opening-closing door, in the case where the information processing apparatus is set to a second position different from a first position that is a printing position where printing is performed by the printer portion, the second position being a position where the weight of the opening-closing door is applied in the direction toward the end portion of the rotation shaft.

2. The information processing apparatus according to claim 1, further comprising
a display portion which displays an image, and
wherein the second position is an image display position for displaying the image on the display portion, and
wherein the opening-closing door lock mechanism maintains the sheet discharge outlet in the closed state by the weight of the opening-closing door in the case where the image display position is a position where the weight of the opening-closing door is applied in the direction toward the end portion of the rotation shaft.

3. The information processing apparatus according to claim 1 or 2, further comprising
an opening-closing door automatic rotation mechanism for allowing the opening-closing door to close the sheet discharge outlet by the weight of the opening-closing door in the case where the information processing apparatus is set to the second position where the weight of the opening-closing door is applied in the direction toward the end portion of the rotation shaft.

4. The information processing apparatus according to claim 3,
wherein the rotation shaft has an eccentrically conical shape where a central axis is deviated,
wherein a bearing into which the rotation shaft is inserted is configured to have a recessed portion which is engaged with the eccentrically conical shape at the position where the opening-closing door is closed, and
wherein the opening-closing door automatic rotation mechanism is configured as a combination of the rotation shaft and the bearing.

5. The information processing apparatus according to claim 3,
wherein the rotation shaft has a sloping rail at a partial area of the end surface of the rotation shaft so that a protrusion amount is gradually increased in a circumferential direction,
wherein a bearing into which the rotation shaft is inserted is configured to have a sloping groove which is engaged with the sloping rail at the position where the opening-closing door is closed, and
wherein the opening-closing door automatic rotation mechanism is configured as a combination of the rotation shaft and the bearing.

6. The information processing apparatus according to any one of claims 1 to 5,
wherein the rotation shaft has a protrusion portion at a partial area of the end surface of the rotation shaft,
wherein a bearing into which the rotation shaft is inserted is configured to have a recessed portion which is engaged with the protrusion portion at the position where the opening-closing door is closed, and
wherein the opening-closing door lock mechanism is configured as a combination of the protrusion portion of the rotation shaft and the recessed portion of the bearing.

7. The information processing apparatus according to any one of claims 1 to 5,
wherein a rotation-shaft-formation surface, where the rotation shaft is formed, has a protrusion portion at a partial area of the rotation-shaft-formation surface,
wherein a bearing-formation surface, where the bearing is formed, is configured to have a recessed portion which is engaged with the protrusion portion at the position where the opening-closing door is closed, and
wherein the opening-closing door lock mechanism is configured as a combination of the protrusion portion of the rotation-shaft-formation surface and the recessed portion of the bearing-formation surface.
